(19) United States
(12) Patent Application Publication
(10) Pub. No.: US 2007/0028259 A1
(43) Pub. Date: Feb. 1, 2007

(54) Broadcasting signal receiving device and control method thereof

(75) Inventor: Ki-won Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/446,211

(22) Filed: Jun. 5, 2006

(30) Foreign Application Priority Data
Jul. 26, 2005 (KR) 10-2005-0068030

(51) Int. Cl. H04N 7/16

(52) U.S. Cl. 725/29; 725/25

(57) ABSTRACT

A method of controlling a broadcasting signal receiving device including a broadcasting receiving part for receiving a broadcasting signal and supporting a viewing restriction function of a broadcasting program, the method comprises: parsing and storing rating information of the broadcasting program included in the received broadcasting signal; generating a user interface for selecting restricted rating information about the viewing restriction function, when the viewing restriction function is selected; storing the restricted rating information selected by a user; and searching the rating information to switch to a channel of viewable rating on the basis of the restricted rating information, when a channel switching function is selected. Additionally, provided is a broadcasting signal receiving device and its control method to promote user's convenience by performing channel switching function, channel list function, and/or broadcasting information display function for the channel of the rating that the user wants to watch.

### CROSS-REFERENCE TO RELATED APPLICATIONS

This application claims priority from Korean Patent Application No. 2005-0068030, filed on Jul. 26, 2005, in the Korean Intellectual Property Office, the disclosure of which is incorporated herein by reference.

### BACKGROUND OF INVENTION

1. Field of Invention

The present invention relates to a broadcasting signal receiving device and its control method, and more particularly, to a broadcasting signal receiving device and its control method for supporting a viewing restriction function of broadcasting programs.

2. Description of the Related Art

In general, terrestrial, cable, and satellite broadcasting transmit additional information for broadcasting programs in addition to the video and audio signals. The additional information for broadcasting programs transmitted at this time may include the rating information.

On the other hand, TV can support a viewing restriction function by using the rating information included in transmitted broadcasting signals. In case of conventional TVs that support such a viewing restriction function of broadcasting programs, the user is provided with a User Interface (UI) to perform the viewing restriction function on broadcasting programs to be received on the basis of the viewing restriction rating indicated by the user. Typically, this function is performed by the Violence (V) chip integrated in TV's.

FIG. 1 is an algorithm of a typical V-chip in conventional TVs. As illustrated in FIG. 1, when the rating information to be blocked is selected by a user, it is established at operation S10.

On the other hand, when channel switching is selected by the user at operation S11, the channel is switched to the next channel up or down from the current channel (S12), and the rating information of the switched channel is received. Then, the block rating information that has been blocked by the user is compared with the rating information of the switched channel at operation S13.

If the rating information of the switched channel corresponds to the rating that has been blocked by the user, then the broadcasting signal of the relevant channel is blocked, and an On Screen Display (OSD) screen for the password input is displayed at operation S14. Here, when the password is entered by the user, the block function of the relevant channel is abandoned.

Furthermore, the aforementioned viewing restriction function in conventional TVs operates regardless of the channel list display function indicating the information of channels allocated to the user and/or the broadcasting information (for example, electronic program guide (EPG) information) display function. In other words, even though the relevant channel corresponds to the channel that has been blocked by the user, the information for that channel will be displayed on the channel list and the broadcasting information.

However, establishing a viewing restriction function by the user means that he or she has no intention to watch the channel corresponding to the block rating, so it may cause inconvenience for the user or may be an unnecessary function that the blocked screen of the channel which corresponds to the block rating is shown, or the information of blocked channels is indicated.

### SUMMARY OF THE INVENTION

An aspect of the present invention to provide a broadcasting signal receiving device and its control method to promote a user's convenience by performing a channel switching function, a channel list function, and/or a broadcasting information display function for the channel of the rating that the user wants to watch.

Another aspect of the present invention can be achieved by providing a method of controlling a broadcasting signal receiving device including a broadcasting receiving part for receiving a broadcasting signal and supporting a viewing restriction function of a broadcasting program, the method comprising: parsing and storing rating information of the broadcasting program included in the received broadcasting signal; generating a UI for selecting restricted rating information about the viewing restriction function, when the viewing restriction function is selected; storing the restricted rating information selected by a user; and searching the rating information to switch to a channel of viewable rating on the basis of the restricted rating information, when a channel switching function is selected.

According to an exemplary embodiment of the present invention, when a channel switching function of a broadcast signal receiving device is selected, the switching of the channel comprises searching the rating of a destination channel sequentially according to the channel switching function on the basis of the restricted rating information, and determining whether the rating of the destination channel is a viewable rating.

Another aspect of the present invention can be achieved by providing a method of controlling a broadcasting signal receiving device including a broadcasting receiving part for receiving a broadcasting signal and supporting a viewing restriction function of a broadcasting program, the method comprising: parsing and storing rating information of the broadcasting program included in the received broadcasting signal; generating a UI for selecting restricted rating information about the viewing restriction function, when the viewing restriction function is selected; storing the restricted rating information selected by a user; and searching the rating information to generate and display a list regarding the channels of viewable rating on the basis of the restricted rating information, when a channel list function is selected.

Another aspect of the present invention can be achieved by providing a method of controlling a broadcasting signal receiving device including a broadcasting receiving part for receiving a broadcasting signal and supporting a viewing restriction function of a broadcasting program, the method comprising: parsing and storing rating information of broadcasting program guide information included in the received broadcasting signal; generating a UI for selecting restricted rating information about the viewing restriction function, when the viewing restriction function of the broadcasting program is selected; storing the restricted rating information selected by a user; and searching the rating information included in the broadcasting program guide information to generate and display a broadcasting program guide table regarding the channels of viewable rating on the basis of the restricted rating information, when a broadcasting program guide information display function is selected.

Another aspect of the present invention can be achieved by providing a broadcasting signal receiving device including a broadcasting receiving part for receiving a broadcasting signal having rating information for a broadcasting program and supporting a viewing restriction function with regard to the rating information, the device comprising: a parsing part for parsing the rating information of the broadcasting program included in the received broadcasting signal; a user selection part; a memory for storing restricted rating information selected through the user selection part; and a control part for searching the rating information to switch to a channel of viewable rating on the basis of the restricted rating information, when a channel switching function is selected through the user selection part.

According to an exemplary embodiment of the present invention, the broadcasting signal receiving device further comprises an UI generation part, wherein, when the viewing restriction function of the broadcasting program is selected through the user selection part, the control part controls the UI generation part to generate an UI menu for selecting the restricted rating information about the viewing restriction function, and when the restricted rating information is selected through the user selection part, the control part stores the restricted rating information that has been selected in the memory.

According to an exemplary embodiment of the present invention, when a channel switching function of a broadcast signal receiving device is selected through the user selection part, the control part searches rating of a destination channel sequentially according to the channel switching function to determine whether the rating of the destination channel is the viewable rating on the basis of the restricted rating information.

According to an exemplary embodiment of the present invention, the rating information is included in at least one of MPEG (Moving Picture Experts Group) user data, PMT (Program Map Table), EIT (Event Information Table), AEIT (Aggregate Event Information Table), and VBI (Vertical Blanking Interval) data.

According to an exemplary embodiment of the present invention, when a channel list function is selected through the user selection part, the control part searches the rating information on the basis of the restricted rating information to control the UI generation part to generate and display a channel list regarding the channels of the viewable rating.

According to an exemplary embodiment of the present invention, the parsing part parses broadcasting program guide information included in the received broadcasting signal, and when a function of displaying the broadcasting program guide information is selected, the control part controls the UI generation part on the basis of the restricted rating information and the rating information to generate and display a broadcasting program guide table about the channels of the viewable rating.

According to an exemplary embodiment of the present invention, when a plurality of restricted ratings are selected through the user selection part, the control part performs the channel switching function on the basis of a plurality of restricted rating information that have been selected.

### BRIEF DESCRIPTION OF THE DRAWINGS

The above and/or other aspects of the present invention will become apparent and more readily appreciated from the following description of the exemplary embodiments, taken in conjunction with the accompany drawings, in which:

FIG. 1 is a flow chart illustrating a viewing restriction function of a V-chip in conventional TVs;

FIGS. 2 and 3 are a block diagram and an UI menu of the TV according to an exemplary embodiment of the present invention; and

FIG. 4 is a flow chart of the TV according to an exemplary embodiment of the present invention.

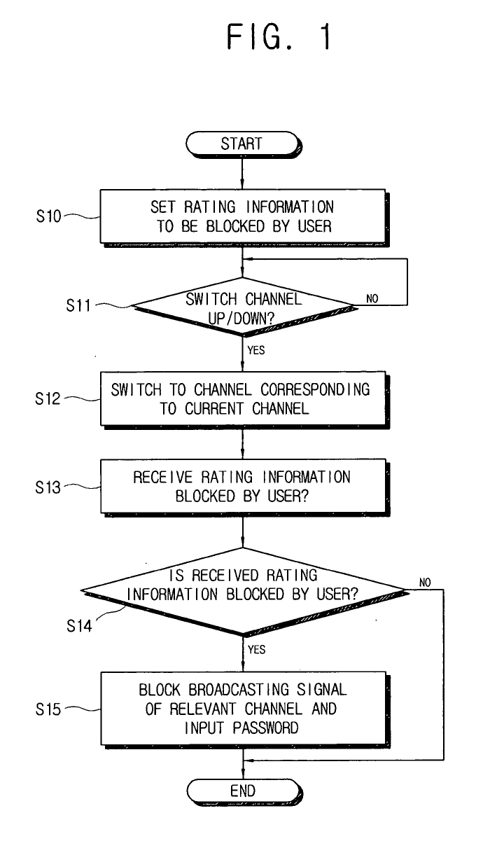

### DETAILED DESCRIPTION OF THE ILLUSTRATIVE, NON-LIMITING EMBODIMENTS OF THE INVENTION

Reference will now be made in detail to exemplary embodiments of the present invention, examples of which are illustrated in the accompanying drawings, wherein like reference numerals refer to like elements throughout. The exemplary embodiments are described below so as to explain the present invention by referring to the figures.

Hereinafter, an exemplary embodiment of the present invention will be described in detail with reference to the accompanying drawings. In an exemplary embodiment of the present invention, the broadcasting signal received by the TV will be assumed to follow the ATSC (Advanced Television Systems Committee).

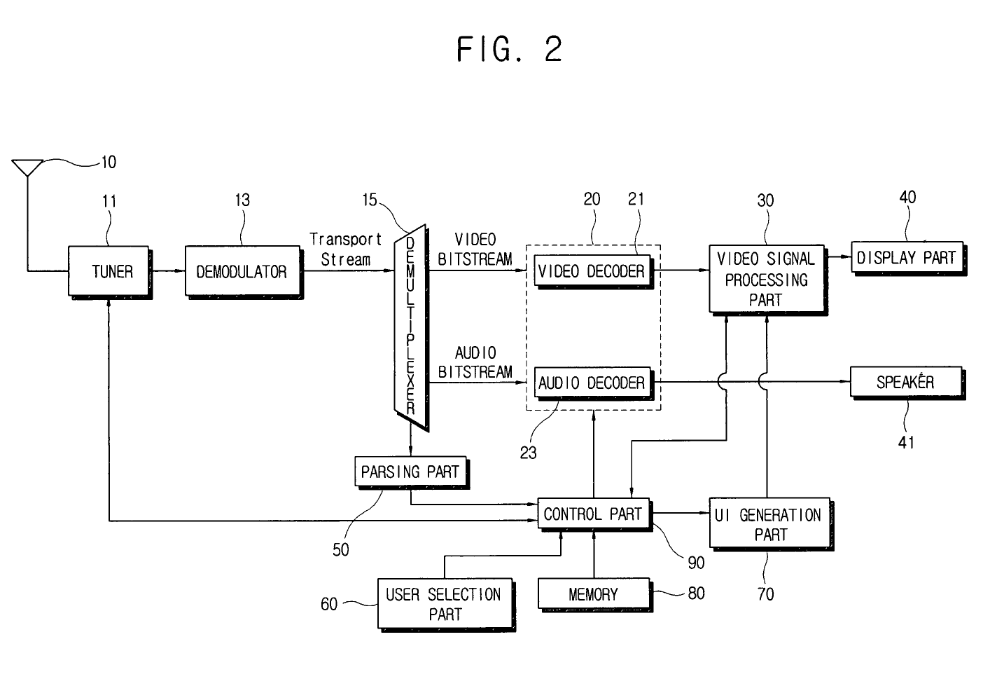

FIG. 2 is a block diagram of a digital TV according to an exemplary embodiment of the present invention. As illustrated in FIG. 2, the digital TV according to the present invention includes an antenna 10, a tuner 11, a demodulator 13, a demultiplexing part 15, a decoding part 20, a video signal processing part 30, a display part 40, a speaker 41, a parsing part 50, a user selection part 60, an UI generation part 70, a memory 80, and a control part 90.

The tuner 11 will tune a broadcasting signal being received through the antenna 10 to the broadcasting signal having its corresponding frequency bandwidth according to the tuning control signal of the control part 90 to be described later. Here, the digital broadcasting signal is transmitted in a form of transport stream in which video signal, audio signal, and various data are multiplexed in time division and packetized.

The broadcasting signal of a specific channel that is tuned by the tuner 11 is outputted in the form of transport stream through the processes of demodulation, error correction, and the like by the demodulator 13. Moreover, it is divided into video stream, audio stream, and data stream by the demultiplexing part 15 and outputted in bitstream format.

The video stream that has been separated through the demultiplexing part 15 is decoded by an MPEG decoder, which is a video decoder 21, and displayed on the display part 40 after processing in the video signal processing part 30. Here, the display part 40 is applicable to various types of display modules such as DLP (Digital Light Processing), LCD (Liquid Crystal Display), PDP (Plasma Display Panel), and the like, and the video signal processing part 30 includes a scaler for converting the video stream into the vertical frequency, resolution, screen ratio, etc. to satisfy the output standard of the display part 40.

Furthermore, the audio stream is decoded by the audio decoder 23 to be outputted to the speaker 41.

On the other hand, various data streams that have been separated through the demultiplexing part 15 are parsed by the parsing part 50 to be stored in a predetermined region of memory (not shown) per each data table.

Here, the data streams being transmitted include the guide information and service information of broadcasting programs. In the ATSC standard, the classifications for the information delivered through the relevant transmission channel and the PSIP (Program and System Information Protocol) for service information such as program guide are specified and used. In the ATSC standard, the classification of a channel is possible without using the PSI (Program Specific Information) standard, which is part of the MPEG-2 system standard, and the PSI is transmitted regardless of its MPEG-2 compatibility. At this time, the broadcasting program guide information stored in the memory (not shown) is combined with the video signal tuned at present through the video signal processing part 30 according to the control of the control part 90 to be described later to be displayed on the display part 40. In this way, the user will know the broadcasting program information (for example, EPG information).

On the other hand, the parsing part 50 parses the rating information contained in the additional data to store in the memory (not shown). Here, the rating information can be known through the content advisory descriptor indicating the values about the rating, which is defined in the user information of MPEG-2, the PMT (Program Map Table) of PSI, the MGT (Master Guide Table) of PSIP, and the RRT (Rating Region Table) of EIT (Event Information Table). In addition, in case of cable broadcasting, it is included in the MPEG-2 user data, PMT, or AEIT (Aggregate Event Information Table), and in case of analog broadcasting, it is included in the VBI (Vertical Blanking Interval) for transmission.

In the digital TV according to an exemplary embodiment of the present invention, the information about internal channel list is stored, and the rating information of the channel parsed by the parsing part 50 can be also stored in this internal channel list. For example, in case of cable broadcasting, when the AEIT is carried by the OpenCable OOB SI, the rating information in the internal channel list will be updated on the basis of the AEIT, and when the AEIT is not carried, the rating information of the relevant channel will be updated in the internal channel list by searching the channel using a different tuner except the tuner tuning a current channel.

The user selection part 60 is provided for user's input such as selecting and releasing a viewing restriction function, channel switching, and the like, and it may include menu keys that are provided in a wireless remote control (not shown), and a key signal generating part for generating key signals (not shown) in response to key manipulation. Here, the user selection part 60 may be provided with mouse, keyboard, or the like, or may be provided with the main panel of digital TV.

Furthermore, the UI generation part 70 generates an UI menu for selecting the rating according to the viewing restriction function by the control of the control part 90 to be described later, and it may also be realized by the OSD (On Screen Display) generation IC, and the like. The UI menu generated in this way is combined with the video signal being processed at present through the video signal processing part 30, and then displayed on the display part.

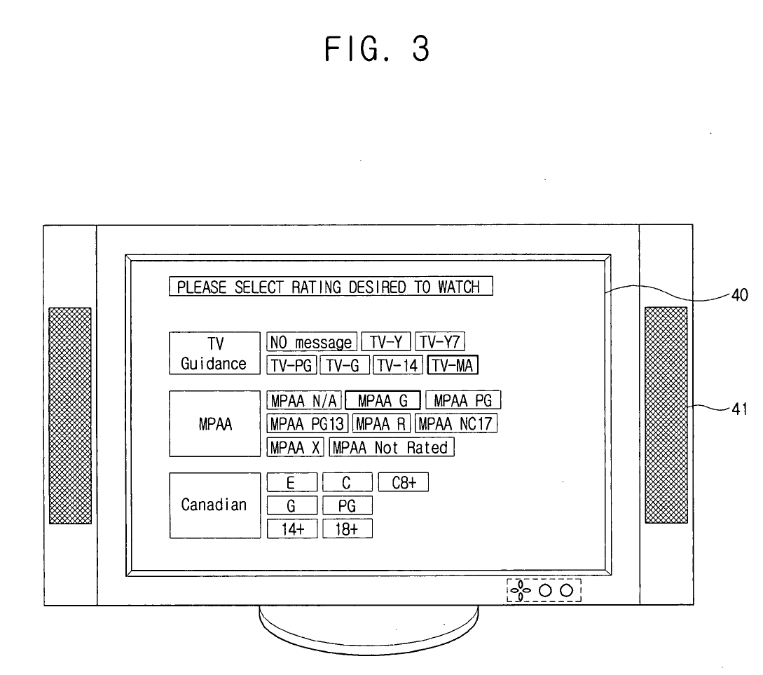

The UI menu for selecting the rating generated by the UI generation part 70 will be described with reference to FIG. 3.

As illustrated in FIG. 2, the UI menu for selecting the rating generated by the UI generation part 70 includes the items for MPAA (Motion Picture Association of America) ratings, as well as the items for TV ratings. In addition, the UI menu may include the items for Canadian community ratings.

The user may select an item corresponding to the rating that he or she wants to watch by manipulating arrow keys in the user selection part 60, or may indicate plural items. In other words, plural ratings that the user wants to watch may be selected. The UI menu, as illustrated in FIG. 3, is an example only, and it can be designed in a variety of ways.

The control part 90 controls each of components to perform the relevant function by the key signal input and/or prescribed program in the user selection part, and it is configured by the controller such as microcomputer, and the like.

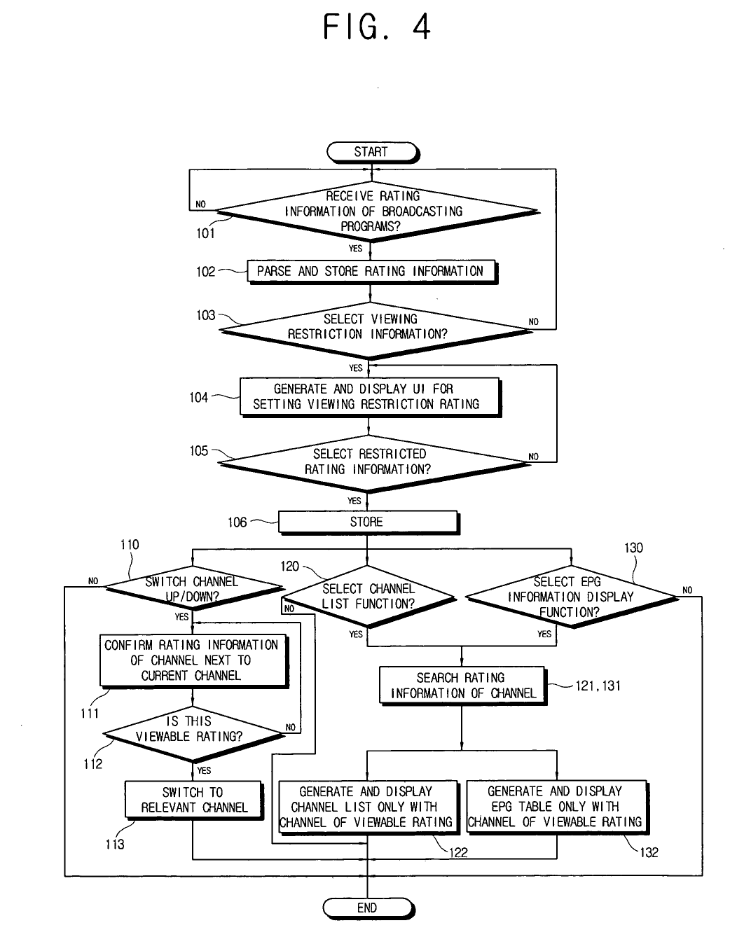

Specifically, the control part 90 takes charge of controlling the signal processing of the received broadcasting signal, etc., as well as controlling the setting of viewing restriction function. In addition, when a variety of functions such as channel switching, channel list display, and/or broadcasting program information display, and the like are selected in the condition that viewing restriction function is set, it confirms the rating information of each channel in the internal channel list on the basis of the viewing restriction rating stored in the memory 80 to perform the relevant function only for one or more channels corresponding to the viewable rating. More specific description for the control part 90 will be described with reference to FIG. 4.

FIG. 4 is a flow chart of a digital TV according to an exemplary embodiment of the present invention.

Among the additional data included in broadcasting signals to be transmitted, the parsing part 50 parses the guide information and service information of broadcasting programs and stores it in the memory (not shown), in particular, when rating information is included in the additional data at operation 101, the parsing part 50 parses the rating information for each channel to be stored in the internal channel list at operation 102.

If viewing restriction function is selected by the user selection part 60 at operation 103, the control part 90 allows the UI generation part 70 to generate and display an UI menu for selecting the viewing restriction rating that the user wants to watch at operation 104. Furthermore, when the rating that the user wants to watch is selected by manipulating the user selection part 60 at operation 105, the control part 90 stores this in the memory 80 at operation 106.

In addition, when the channel switching function of a television is selected by the user selection part 60 at operation 110, the control part 90 confirms the rating information of the next channel, which is a switched destination channel, through the internal channel list stored in the memory 80 at operation 111.

The control part 90 determines whether the rating information of the switched destination channel corresponds to the rating that the user wants to watch at operation 112, and if it corresponds to a viewable rating, the channel will be switched to the relevant channel at operation 113, and if it does not correspond to a viewable rating, the rating information of the next channel will be confirmed at operation 111. Such operations 111 through 113 will be executed repeatedly until the user finds the channel of the rating that he or she wants to watch.

For example, assume that the user sets up TV-Y and MPAA G as the rating that he or she wants to watch on the UI menu of FIG. 3, and the up channel switch button is selected through the user selection part 60 while watching the channel 50-1 at present, when the channel 50-2 is rated as TV-Y7 the channel 50-3 as TV-MA, and the channel 50-4 as MPAA G, then the control part 90 will search the internal channel list, and skip the channels 50-2 and 50-3, and switch to the channel 50-4 directly from the channel 50-1. In other words, the channels of the rating that the user does not want to watch will be skipped.

If the channel list display function is selected through the user selection part 60 at operation 120, then the control part 90 searches the internal channel list at operation 121, to control the UI generation part 70, thereby generating a channel list only with the channels corresponding to the rating that the user chooses to, watch at operation 122. In the aforementioned example, the channels 50-2 and 50-3 corresponding to the rating that the user does not want to watch will not be displayed in the channel list.

Furthermore, when the function of displaying broadcasting program guide information, for example, EPG information, is selected by the user through the user selection part 60 at operation 130, the control part 90 searches the internal channel list at operation 131 to control the UI generation part 70, thereby generating an EPG table only with the channels corresponding to the rating that the user chooses to watch at operation 132. The EPG information generated in this way is combined with the video signal of the current channel, and displayed on the display part 40. By means of this, the user can confirm the broadcasting information only about one or more channels corresponding to the rating that he or she wants to watch. Therefore, when a viewing restriction function is selected, a user's intention can be satisfied by performing the relevant function only on one or more channels corresponding to the rating that the user wants to watch in connection with performing the function about digital TV channels.

The present invention can be applied to a broadcasting signal receiving device for receiving terrestrial, cable, and/or satellite broadcasting signals, and also applied to a broadcasting signal receiving device for receiving analog broadcasting signals other than digital broadcasting signal. Moreover, the present invention can be applied to other functions related to channels, in addition to channel switching function, channel list function, and broadcasting program guide information display function.

As described above, according to the present invention, a broadcasting signal receiving device and its control method to promote user's convenience is provided by performing the channel switching function, channel list function and/or broadcasting information display function on the channels of the rating that the user wants to watch.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of controlling a broadcasting signal receiving device, including a broadcasting receiving part for receiving a broadcasting signal and supporting a broadcasting program viewing restriction function, the method comprising:
parsing and storing broadcast program rating information included in the received broadcasting signal;
generating a user interface for selecting restricted rating information about the viewing restriction function, when the viewing restriction function is selected;
storing the restricted rating information selected by a user; and
searching the rating information to switch to a channel of a viewable rating on the basis of the restricted rating information, when a channel switching function is selected.

2. The method of controlling a broadcasting signal receiving device according to claim 1, wherein, when the channel switching function is selected, the switching of the channel comprises searching a rating of a destination channel sequentially according to the channel switching function on the basis of the restricted rating information, and determining whether the rating of the destination channel is the viewable rating.

3. The method of controlling a broadcasting signal receiving device according to claim 1, wherein, when an up/down switching function of channel is selected, the switching of the channel comprises searching a rating of a destination channel sequentially according to the up/down switching function on the basis of the restricted rating information, and determining whether the rating of the destination channel is the viewable rating.

4. A method of controlling a broadcasting signal receiving device, including a broadcasting receiving part for receiving a broadcasting signal and supporting a broadcast program viewing restriction function, the method comprising:
parsing and storing broadcast program rating information included in the received broadcasting signal;
generating a user interface for selecting restricted rating information about the viewing restriction function, when the viewing restriction function is selected;
storing the restricted rating information selected by a user; and
searching the stored rating information to generate and display a list of one or more channels of viewable rating on the basis of the restricted rating information, when a channel list function is selected.

5. A method of controlling a broadcasting signal receiving device, including a broadcasting receiving part for receiving a broadcasting signal and supporting a broadcast program viewing restriction function, the method comprising:
parsing and storing broadcasting program guide information rating information included in the received broadcasting signal;
generating a user interface for selecting restricted rating information about the viewing restriction function, when the viewing restriction function of the broadcasting program is selected;
storing the restricted rating information selected by a user; and
searching the broadcasting program guide information rating information to generate and display a broadcasting program guide table about one or more channels of viewable rating on the basis of the restricted rating information, when a broadcasting program guide information display function is selected.

6. A broadcasting signal receiving device comprising:
a broadcasting receiving unit which receives a broadcasting signal having broadcasting program rating information and supports a viewing restriction function with regard to the broadcasting program rating information;
a parsing unit which parses the rating information of the broadcasting program included in the received broadcasting signal;
a user selection unit;
a memory which stores restricted rating information selected through the user selection unit; and
a control unit which searches the rating information to switch to a channel of viewable rating on the basis of the restricted rating information, when a channel switching function is selected through the user selection unit.

7. The broadcasting signal receiving device according to claim 6, further comprising a user interface generation unit,
wherein, when the viewing restriction function is selected through the user selection unit, the control unit controls the user interface generation unit to generate a user interface menu which allows a user to select the restricted rating information about the viewing restriction function, and when the restricted rating information is selected through the user selection unit, the control unit stores the selected restricted rating information in the memory.

8. The broadcasting signal receiving device according to claim 7, wherein, when the channel switching function is selected through the user selection unit, the control unit searches a rating of a destination channel sequentially according to the channel switching function to determine whether the rating of the destination channel is a viewable rating on the basis of the restricted rating information.

9. The broadcasting signal receiving device according to claim 7, wherein, when an up/down switching function of channel is selected through the user selection unit, the control unit searches a rating of a destination channel sequentially according to the up/down switching function to determine whether the rating of the destination channel is a viewable rating on the basis of the restricted rating information.

10. The broadcasting signal receiving device according to Claim 8, wherein the rating information is included in at least one of MPEG (Moving Picture Experts Group) user data, PMT (Program Map Table), EIT (Event Information Table), AEIT (Aggregate Event Information Table), and VBI (Vertical Blanking Interval) data.

11. The broadcasting signal receiving device according to claim 8, wherein, when a channel list function is selected through the user selection unit, the control unit searches the rating information on the basis of the restricted rating information to control the user interface generation unit to generate and display a channel list regarding one or more channels of the viewable rating.

12. The broadcasting signal receiving device according to claim 8, wherein the parsing unit parses broadcasting program guide information included in the received broadcasting signal, and when a function of displaying the broadcasting program guide information is selected, the control unit controls the user interface generation part on the basis of the restricted rating information and the rating information to generate and display a broadcasting program guide table regarding the channels of the viewable rating.

13. The broadcasting signal receiving device according to claim 7, wherein, when a plurality of restricted ratings are selected through the user selection part, the control unit performs the channel switching function on the basis of a plurality of restricted rating information that have been selected.
